(19) United States
(12) Patent Application Publication
(10) Pub. No.: US 2025/0274786 A1
(43) Pub. Date: Aug. 28, 2025

(54) BEAM MANAGEMENT PROCEDURE FOR A USER EQUIPMENT GROUP

(71) Applicant: QUALCOMM Incorporated, San Diego, CA (US)

(72) Inventors: Hui GUO, Beijing (CN); Tien Viet NGUYEN, Bridgewater, NJ (US); Kapil GULATI, Belle Mead, NJ (US); Shuanshuan WU, San Diego, CA (US); Karthika PALADUGU, Hyderabad (IN)

(21) Appl. No.: 18/858,213

(22) PCT Filed: Jun. 16, 2022
(86) PCT No.: PCT/CN2022/099084

§ 371 Date: Oct. 18, 2024

(51) Int. Cl. H04W 24/04; H04W 24/08

(52) U.S. Cl. CPC H04W 24/04; H04W 24/08

(57) ABSTRACT

Methods, systems, and devices for wireless communication are described. In some examples, a user equipment (UE) may transmit, to a network entity, signaling including an indication of a group configuration for a UE group. The group configuration may include a group leader UE, one or more group member UEs, and an identifier mapping between the group leader UE and the one or more group member UEs. The group member UEs may be within a quasi co-location threshold of the group leader UE. The UE may perform a beam management procedure to measure multiple transmit beams and identify a transmit beam for communications between the network entity and the UE group. The UE may transmit the message indicating the transmit beam to the network entity. The methods, systems, and devices described herein may reduce beam management efforts for group member UEs, thus reducing power consumption and latency in beam management procedures.

### CROSS REFERENCE

The present application is a 371 national stage filing of International PCT Application No. PCT/CN2022/099084 by GUO et al. entitled “BEAM MANAGEMENT PROCEDURE FOR A USER EQUIPMENT GROUP,” filed Jun. 16, 2022, which is assigned to the assignee hereof, and which is expressly incorporated by reference in its entirety herein.

### FIELD OF TECHNOLOGY

The following relates to wireless communication at a user equipment (UE), including beam management procedure for a UE group.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some wireless communications systems, a UE may perform a beam management procedure to determine a transmission beam for communicating with a network entity. However, this procedure may increase the latency of communication, in some scenarios.

### SUMMARY

The described techniques relate to improved methods, systems, devices, and apparatuses that support beam management procedure for a user equipment (UE) group. For example, the described techniques provide for enhanced beam management procedures for a group of UEs. In some wireless communications systems, one or more user equipment (UEs) may form a group based on similar quasi co-location information. For example, the group may include a group leader UE and one or more group member UEs. The group leader UE and group member UEs may be connected to a network entity. Additionally, the group leader UE and the group member UEs may be connected to each other via a sidelink interface. In some examples, the group leader UE may transmit, to the network entity, an indication of the group member UEs. The group leader UE may perform a beam management procedure to measure a set of transmit beams and identify a transmit beam of the set of transmit beams for communications between the network entity and the UE group. The group leader UE may then transmit a message indicating the transmit beam of the set of transmit beams.

A method for wireless communication at a UE is described. The method may include transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE, performing a beam management procedure to measure a set of multiple transmit beams and identify a transmit beam of the set of multiple transmit beams for communications between the network entity and the UE group, and transmitting a message indicating the transmit beam of the set of multiple transmit beams.

An apparatus for wireless communication at a UE is described. The apparatus may include a processor, memory coupled with the processor, and instructions stored in the memory. The instructions may be executable by the processor to cause the apparatus to transmit, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE, perform a beam management procedure to measure a set of multiple transmit beams and identify a transmit beam of the set of multiple transmit beams for communications between the network entity and the UE group, and transmit a message indicating the transmit beam of the set of multiple transmit beams.

Another apparatus for wireless communication at a UE is described. The apparatus may include means for transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE, means for performing a beam management procedure to measure a set of multiple transmit beams and identify a transmit beam of the set of multiple transmit beams for communications between the network entity and the UE group, and means for transmitting a message indicating the transmit beam of the set of multiple transmit beams.

A non-transitory computer-readable medium storing code for wireless communication at a UE is described. The code may include instructions executable by a processor to transmit, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE, perform a beam management procedure to measure a set of multiple transmit beams and identify a transmit beam of the set of multiple transmit beams for communications between the network entity and the UE group, and transmit a message indicating the transmit beam of the set of multiple transmit beams.

In some examples of the method, apparatuses, and non-transitory computer-readable medium described herein, transmitting the message may include operations, features, means, or instructions for transmitting a channel state information reference signal resource indication associated with the transmit beam of the set of multiple transmit beams or a reference signal receive power measurement report associated with the transmit beam of the set of multiple transmit beams, or both.

Some examples of the method, apparatuses, and non-transitory computer-readable medium described herein may further include operations, features, means, or instructions for transmitting, to the one or more group member UEs, a second message indicating the transmit beam of the set of multiple transmit beams.

Some examples of the method, apparatuses, and non-transitory computer-readable medium described herein may further include operations, features, means, or instructions for receiving, from the network entity, a transmission configuration indication associated with the transmit beam of the set of multiple transmit beams.

Some examples of the method, apparatuses, and non-transitory computer-readable medium described herein may further include operations, features, means, or instructions for transmitting, to the one or more group member UEs, a sidelink control information signaling indicating the transmission configuration indication associated with the transmit beam of the set of multiple transmit beams.

Some examples of the method, apparatuses, and non-transitory computer-readable medium described herein may further include operations, features, means, or instructions for receiving, from the network entity, a downlink control information signaling including a transmission configuration indication associated with the transmit beam of the set of multiple transmit beams, where the downlink control information signaling may be scrambled using an identifier for the UE group associated with the UE.

In some examples of the method, apparatuses, and non-transitory computer-readable medium described herein, the downlink control information signaling includes a request for the UE to perform the beam management procedure.

Some examples of the method, apparatuses, and non-transitory computer-readable medium described herein may further include operations, features, means, or instructions for receiving, from the network entity, an indication of transmit beam resources based on transmitting the message indicating the transmit beam, where the transmit beam resources may be associated with a set of narrow transmit beams.

In some examples of the method, apparatuses, and non-transitory computer-readable medium described herein, the set of narrow transmit beams include a subset of beams associated with the transmit beam indicated in the message.

Some examples of the method, apparatuses, and non-transitory computer-readable medium described herein may further include operations, features, means, or instructions for performing a second beam management procedure to measure the set of narrow transmit beams and transmitting, to the network entity, a second message indicating a narrow transmit beam of the set of narrow transmit beams based on the second beam management procedure.

Some examples of the method, apparatuses, and non-transitory computer-readable medium described herein may further include operations, features, means, or instructions for performing a beam failure detection for the group leader UE and the one or more group member UEs of the UE group.

Some examples of the method, apparatuses, and non-transitory computer-readable medium described herein may further include operations, features, means, or instructions for transmitting, to the one or more group member UEs, a request to monitor for a beam failure detection for the group leader UE and the one or more group member UEs of the UE group and to perform a beam failure recovery based on performing the beam failure detection.

In some examples of the method, apparatuses, and non-transitory computer-readable medium described herein, the group leader UE and the one or more group member UEs of the UE group communicate according to a new transmit beam based on the beam failure recovery.

In some examples of the method, apparatuses, and non-transitory computer-readable medium described herein, the request includes a groupcast request including an identifier for the UE group or a broadcast request including the identifier for the UE group.

Some examples of the method, apparatuses, and non-transitory computer-readable medium described herein may further include operations, features, means, or instructions for transmitting, to the network entity, a second message including an indication of at least one motion estimate for the group leader UE and the one or more group member UEs of the UE group.

In some examples of the method, apparatuses, and non-transitory computer-readable medium described herein, the at least one motion estimate includes a moving direction, a velocity, or both.

Some examples of the method, apparatuses, and non-transitory computer-readable medium described herein may further include operations, features, means, or instructions for transmitting, to the network entity, a second message including an indication of a recommended beam index subset or a restricted beam index subset or both for the group leader UE and the one or more group member UEs of the UE group.

A method for wireless communication at a network entity is described. The method may include receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE and receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

An apparatus for wireless communication at a network entity is described. The apparatus may include a processor, memory coupled with the processor, and instructions stored in the memory. The instructions may be executable by the processor to cause the apparatus to receive, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE and receive, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

Another apparatus for wireless communication at a network entity is described. The apparatus may include means for receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE and means for receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

A non-transitory computer-readable medium storing code for wireless communication at a network entity is described. The code may include instructions executable by a processor to receive, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE and receive, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

In some examples of the method, apparatuses, and non-transitory computer-readable medium described herein, receiving the message may include operations, features, means, or instructions for receiving, from the UE, a channel state information reference signal resource indication associated with the transmit beam of the set of multiple transmit beams or a reference signal receive power measurement report associated with the transmit beam of the set of multiple transmit beams or both.

Some examples of the method, apparatuses, and non-transitory computer-readable medium described herein may further include operations, features, means, or instructions for transmitting a transmission configuration indication associated with the transmit beam of the set of multiple transmit beams.

In some examples of the method, apparatuses, and non-transitory computer-readable medium described herein, the transmitting may include operations, features, means, or instructions for transmitting the transmission configuration indication to the group leader UE or to the group leader UE and the one or more group member UEs of the UE group.

Some examples of the method, apparatuses, and non-transitory computer-readable medium described herein may further include operations, features, means, or instructions for transmitting, to the UE, a downlink control information signaling including a transmission configuration indication associated with the transmit beam of the set of multiple transmit beams, where the downlink control information signaling may be scrambled using an identifier for the UE group associated with the UE.

In some examples of the method, apparatuses, and non-transitory computer-readable medium described herein, the downlink control information signaling includes a request for the UE to perform the beam management procedure.

Some examples of the method, apparatuses, and non-transitory computer-readable medium described herein may further include operations, features, means, or instructions for transmitting, to the UE, an indication of transmit beam resources based on receiving the message indicating the transmit beam, where the transmit beam resources may be associated with a set of narrow transmit beams.

In some examples of the method, apparatuses, and non-transitory computer-readable medium described herein, the set of narrow transmit beams include a subset of beams associated with the transmit beam indicated in the message.

Some examples of the method, apparatuses, and non-transitory computer-readable medium described herein may further include operations, features, means, or instructions for receiving, from the group leader UE and the one or more group member UEs, a set of multiple messages indicating a set of multiple narrow transmit beams of the set of narrow transmit beams and transmitting an indication of a narrow transmit beam of the set of narrow transmit beams selected for each of the group leader UE and the one or more group member UEs based at least in part receiving the set of multiple messages.

Some examples of the method, apparatuses, and non-transitory computer-readable medium described herein may further include operations, features, means, or instructions for receiving, from the UE, a second message including an indication of at least one motion estimate for the group leader UE and the one or more group member UEs of the UE group.

In some examples of the method, apparatuses, and non-transitory computer-readable medium described herein, the at least one motion estimate includes a moving direction, a velocity, or both.

Some examples of the method, apparatuses, and non-transitory computer-readable medium described herein may further include operations, features, means, or instructions for receiving, from the UE, a second message including an indication of a recommended beam index subset or a restricted beam index subset or both for the group leader UE and the one or more group member UEs of the UE group.

### BRIEF DESCRIPTION OF THE DRAWINGS

FIG. 1 illustrates an example of a wireless communications system that supports beam management procedure for a user equipment (UE) group in accordance with one or more aspects of the present disclosure.

FIG. 2 illustrates an example of a wireless communications system that supports beam management procedure for a UE group in accordance with one or more aspects of the present disclosure.

FIG. 3 illustrates an example of a process flow that supports beam management procedure for a UE group in accordance with one or more aspects of the present disclosure.

FIG. 4 illustrates an example of a process flow that supports beam management procedure for a UE group in accordance with one or more aspects of the present disclosure.

FIGS. 5 and 6 show block diagrams of devices that support beam management procedure for a UE group in accordance with one or more aspects of the present disclosure.

FIG. 7 shows a block diagram of a communications manager that supports beam management procedure for a UE group in accordance with one or more aspects of the present disclosure.

FIG. 8 shows a diagram of a system including a device that supports beam management procedure for a UE group in accordance with one or more aspects of the present disclosure.

FIGS. 9 and 10 show block diagrams of devices that support beam management procedure for a UE group in accordance with one or more aspects of the present disclosure.

FIG. 11 shows a block diagram of a communications manager that supports beam management procedure for a UE group in accordance with one or more aspects of the present disclosure.

FIG. 12 shows a diagram of a system including a device that supports beam management procedure for a UE group in accordance with one or more aspects of the present disclosure.

FIGS. 13 through 16 show flowcharts illustrating methods that support beam management procedure for a UE group in accordance with one or more aspects of the present disclosure.

### DETAILED DESCRIPTION

In some wireless communications systems, one or more user equipment (UEs) may form a group of UEs. For example, one or more UEs may form a group based on similar quasi co-location information. In some instances, the group may include a group leader UE and one or more group member UEs. The group leader UE and group member UEs may be connected to a network entity via a radio interface (e.g., Uu interface). Additionally, the group leader UE and the group member UEs may be connected to each other via a sidelink interface (e.g., a PC5 interface). In some cases, the group leader UE and the group members UEs may each perform a beam sweeping procedure to measure a beam for transmission or reception. Each UE within the group may transmit the beam measurements to the network entity via a channel state information reference signal report. The network entity may select and indicate the transmission or reception beam to each UE within the group.

In some cases, the group of UEs may be traveling in the same orientation and may be at the same velocity causing the group of UEs to have same or similar quasi co-location information characteristics. In such cases, the selected beam for each UE in the group may also be the same. Thus, having each UE within the group perform the beam sweeping procedure individually may be unnecessary and result in an increased use of power and an increase in latency for each UE. Latency and power consumption may further increase when the group of UEs are in a high-speed scenario (e.g., a group of UEs within a vehicle UE), which results in more frequent beam sweeping procedures. Thus, current beam management procedures may be improved for beam management within a group of UEs.

One or more techniques described herein may provide for enhanced beam management procedures for a group of UEs. In some implementations, the group leader UE may transmit, to the network entity, an indication of the group UEs. For example, the indication may include the group identification. The group leader UE may perform the beam sweeping procedure to select a beam for communicating with the group of UEs. The group leader UE may transmit an indication of the measured beams to the network entity via a channel state information reference signal report. The network entity may transmit a transmission configuration indication that includes an indication of the selected transmission beam. The network entity may transmit the transmission configuration indication to each UE in the group. Alternatively, the network entity may transmit the transmission configuration indication to the group leader UE and the group leader UE may forward the transmission configuration indication to the group member UEs via a sidelink interface.

In some other implementations, the group leader UE may perform a coarse beam sweeping procedure. For example, the group leader UE may measure one or more coarse beams and transmit an indication of a coarse beam of the one or more coarse beams to the network entity. The network entity may transmit, based on the received coarse beam, narrow beam resources for measurement at the group member UEs. The group member UEs may measure the indicated narrow beam resources and may select a transmission beam for upcoming transmissions. In the case of a beam failure, the group leader UE may perform the beam failure detection and beam failure recovery on behalf of the group. Once a new beam has been detected, the group member UEs may switch to communicating on the recovered beam.

Aspects of the present disclosure may be implemented to realize one or more advantages. The described techniques may reduce the group member UE beam management efforts. For example, the group leader UE may perform the beam management procedure on behalf of the group. Thus, by having the group leader UE perform a beam management and a beam detection procedure on behalf of the group, the beam management efforts by the group member UEs may reduce thereby reducing latency in beam selection and improving power efficiency of the group member UEs.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to beam management procedure for a UE group.

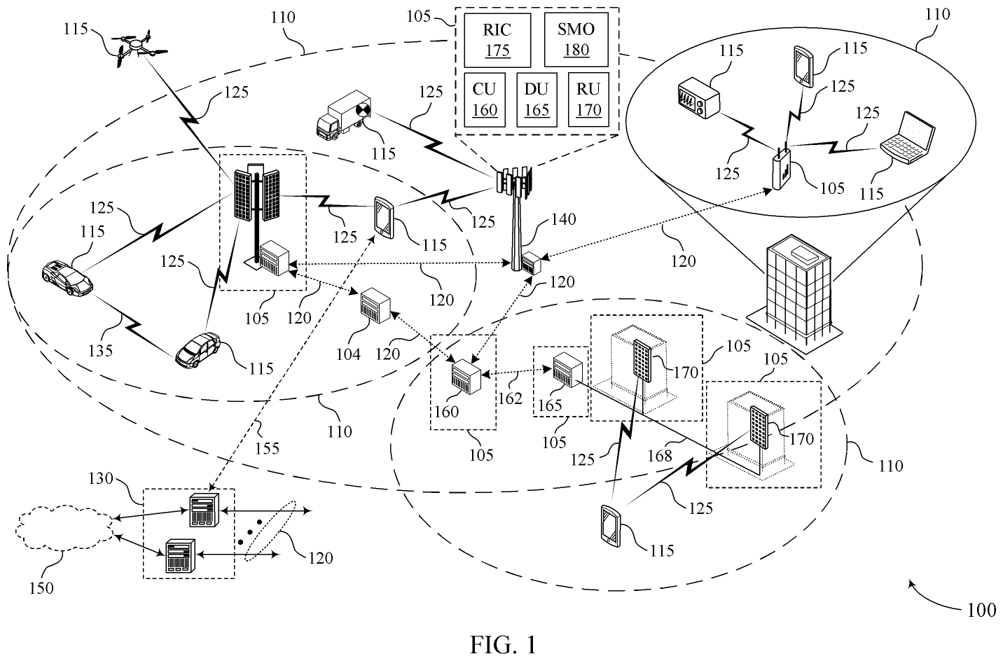

FIG. 1 illustrates an example of a wireless communications system 100 that supports beam management procedure for a UE group in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support beam management procedure for a UE group as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems (e.g., NR communications systems), the use of millimeter waves may increase the data rate between the network entity 105 and the UE 115. However, wireless communications systems supporting millimeter waves may experience poor propagation characteristics due to one or more environmental factors. To overcome the poor propagation characteristics, the network entity 105 or the UE 115 may employ a number of antennas and form narrow beams. Millimeter wave channels may be more deterministic given an environmental geometry, compared to waves of lower frequencies. Thus, wireless communications system 100 may utilize the techniques depicted herein to attain beam alignment between the network entity 105 and the UE 115. For example, the UE 115 may perform a beam management procedure to determine a transmission beam for communication with the network entity 105.

In some wireless communications systems, one or more UEs 115 may form a group initiated by a group leader UE 115. The group may include the group leader UE 115 and one or more group member UEs 115. The group leader UE 115 may transmit an indication of the group to the network entity 105. Due to similar quasi co-location characteristics of the group, the group leader UE 115 may perform the beam management procedure to determine the transmission beam for the group. The group leader UE may transmit, via a channel state information report, an indication of the selected transmission beam to the network entity 105. In some implementations, the network entity 105 may indicate the selected transmission beam to the group leader UE. The group leader UE may forward the selected transmission beam to the group member UEs. Alternatively, the network entity 105 may transmit the selected beam to each UE 115 in the group.

Aspects of the present disclosure may be implemented to realize one or more advantages. The described techniques may reduce the group member UEs 115 beam management efforts. For example, the group leader UE 115 may perform the beam management procedure on behalf of the group, thus, reducing latency in beam selection and improving power efficiency of the group member UEs 115.

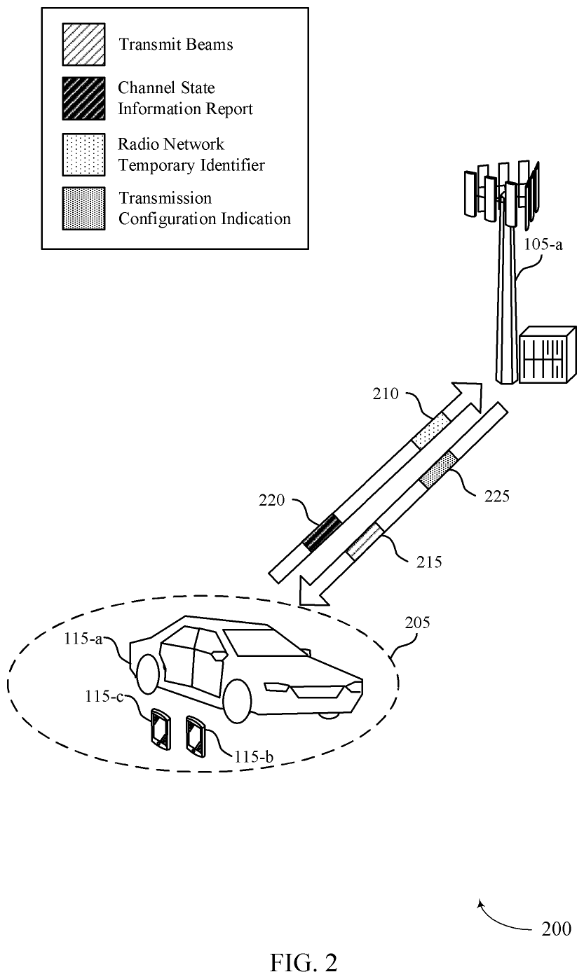

FIG. 2 illustrates an example of a wireless communications system 200 that supports beam management procedure for a UE group in accordance with one or more aspects of the present disclosure. For example, the wireless communications system 200 may include a network entity 105-a, which may be an example of a network entity 105 described with reference to FIG. 1. Likewise, the wireless communications system 200 may include a UE 115-a, a UE 115-b, and a UE 115-c, which may be examples of a UE 115 described with reference to FIG. 1.

The wireless communications system 200 may be an example of a vehicle-to-everything (V2X) system. For example, the UE 115-a may be an example of a vehicle, and the UE 115-b and the UE 115-c may be examples of mobile devices carried by passengers or the driver of the UE 115-a. The UE 115-a, the UE 115-b, and the UE 115-c may be connected to the network entity 105-a via a Uu interface. The UE 115-a, the UE 115-b, and the UE 115-c may be connected and communicate via a sidelink interface. In some cases, the UE 115-a, the UE 115-b, and the UE 115-c may form a group. For example, the UE 115-a may initiate a group, and the UE 115-b and the UE 115-c may join the group. In some cases, the UE 115-a, the UE 115-b, and the UE 115-c may be multi-mode terminals. In such cases, the UEs 115 may form multiple groups in the same vehicle. The UE 115-a may be the group leader UE, while the UE 115-b and the UE 115-c may be group member UEs.

In some examples of the wireless communications system 200, the UE 115-a, the UE 115-b, and the UE 115-c may each measure a reference signal received power for a set of transmission beams 215 to determine a transmission beam for communications between the network entity 105-a and the UEs 115. The network entity may transmit a physical downlink shared channel (PDSCH), user data, or reference signals with the selected transmission beam and antenna weight to achieve a higher signal-to-noise ratio (SNR).

However, exhaustive beam sweeping measurements by each UE 115 in the group may reduce the power of each UE 115 and increase latency in communications. Additionally, in high-speed scenarios, more frequent beam tracking processes may further reduce the battery life of the UEs 115 and increase latency in beam management. As the UE 115-a, the UE 115-b, and the UE 115-c move in the same direction at the same velocity, the wireless channel between the network entity 105-a and the UEs 115 may have similar quasi co-location characteristics. Thus, a beam management procedure may be utilized to maximally leverage the same motional status for the UEs 115. In other words, the UE 115-a, the UE 115-b, and the UE 115-c may be within a quasi co-location threshold 205, thus having similar quasi co-location characteristics. The beam management procedure may leverage the similar quasi co-location characteristics to reduce beam sweeping efforts by the UE 115-b and the UE 115-c.

For example, the UE 115-a may transmit a radio network temporary identifier report 210 indicating the formation of the group to the network entity 105-a. For example, the radio network temporary identifier report 210 may include an indication that the UE 115-a is the group leader UE and the UE 115-b and the UE 115-c are group member UEs. The network entity 105-a may transmit a set of transmission beams 215 to the UE 115-a. The UE 115-a may measure the reference signal receive power of the set of transmission beams to determine the transmission beam on behalf of the UE 115-b and the UE 115-c. The UE 115-a may indicate the transmission beam to the network entity 105-a via the channel state information report 220. The network entity 105-a may transmit a transmission configuration indication 225 (or other indications) that indicates the selected transmission beam to the group of UEs. In some cases, the network entity 105-a may transmit the transmission configuration indication 225 to the UE 115-a. In such cases, the UE 115-a may forward the transmission configuration indication 225 to the UE 115-b and the UE 115-c. In some other cases, the network entity 105-a may transmit the transmission configuration indication 225 to the UE 115-a, the UE 115-b and, the UE 115-c respectively.

Additionally or alternatively, the UE 115-a, the UE 115-b, or the UE 115-c may perform a beam failure detection procedure and a beam failure recovery procedure. For instance, a UE 115 may independently perform beam failure detection, instead of every member UE of a group of UEs. In some cases, the network entity 105-a may configure the beam failure detection procedure and the beam failure recovery procedure at the time of group formation (e.g., once one UE joins the group). In another case, the UE 115-a may indicate the beam failure detection procedure and the beam failure recovery procedure via a group-cast or broadcast message to the UE 115-b and the UE 115-c. The groupcast or broadcast may include the group identifier.

Further, the UE 115-a, the UE 115-b, or the UE 115-c may independently perform the beam failure detection procedure instead of every member of the group. In some cases, the UE 115-a may perform the beam failure detection procedure on behalf of all the members of the UE group. In some other cases, the UE 115-a may transmit an indication to the UE 115-b or the UE 115-c to perform the beam failure detection procedure. Upon detection of a beam failure, the UE 115-a may perform the beam failure recovery procedure for the group. Alternatively, the UE 115-a may transmit an indication via a sidelink interface to the UE 115-b or the UE 115-c to perform the beam failure recovery procedure. The UE 115-a, the UE 115-b, and the UE 115-c may switch to the recovered beam following the completion the beam failure detection procedure and the beam failure recovery procedure.

In some implementations of the wireless communications system 200, a group-based beam tracking procedure may be performed. For example, the UE 115-a may have a current motional status as well as future orientations (e.g., autonomous driving or motion prediction based on navigations) for the UE 115-a, the UE 115-b, and the UE 115-c. The UE 115-a may transmit the current motional estimates, the future motional predictions, and the group identifier to the network entity 105-a. The current motional status may assist the network entity 105-a in transmission beam tracking for the group of UEs. For example, the UE 115-a may transmit an indication of a direction and an indication of velocity to the network entity 105-a. The network entity 105-a may decide or determine a subset of beam sweeping resources for the group UEs 115 to save on power and processing complexity. Additionally, or alternatively, the UE-115-a may associate beam directions to a network transmission beam index and may transmit a recommended beam index subset or restricted beam index subset to the network entity 105-a.

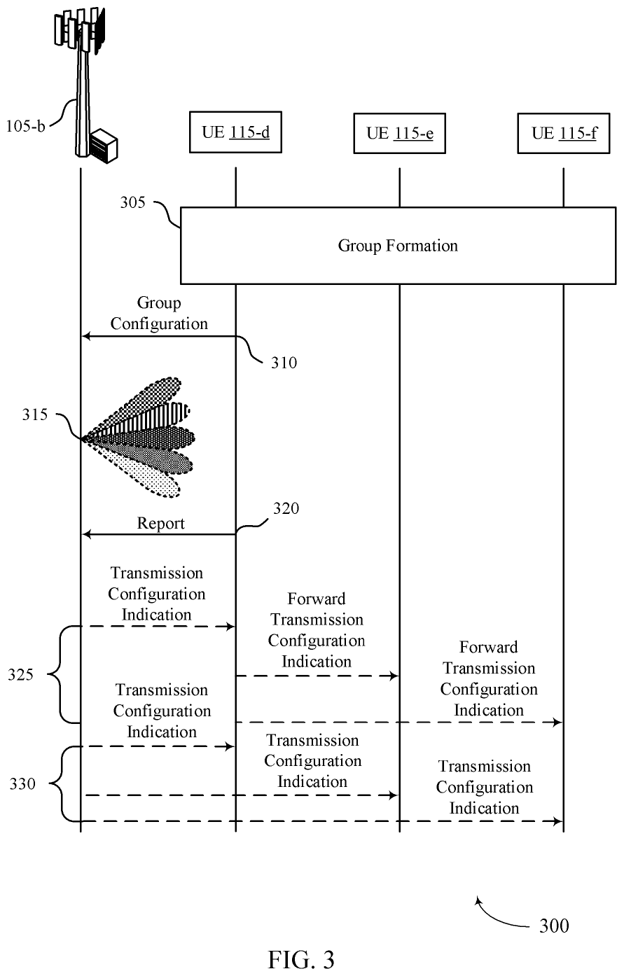

FIG. 3 illustrates an example of a process flow 300 that supports beam management procedure for a UE group in accordance with one or more aspects of the present disclosure. For example, the process flow 300 may include a network entity 105-b, which may be an example of corresponding network entities 105 described with reference to FIGS. 1 and 2. Likewise, the process flow 300 may include a UE 115-d, a UE 115-e, and a UE 115-f which may be examples of corresponding UEs 115 described with reference to FIGS. 1 and 2.

At 305, the UE 115-d, the UE 115-e, and the UE 115-f may form a group. For example, the UE 115-e and the UE 115-f may be within a quasi co-location threshold of the UE 115-d. The UE 115-d may be the group leader UE and the UE 115-e and the UE 115-f may be group member UEs. In some examples, the UE 115-d, the UE 115-e, and the UE 115-f may join the same in-vehicle group with the UE 115-d being an example of a UE 115-a described herein with reference to FIG. 2.

At 310, the UE 115-d may transmit, and the network entity 105-b may receive, signaling that includes an indication of the group configuration. For example, the group configuration may include identification of the group leader UE, the group member UEs, and an identifier mapping between the UE 115-d, the UE 115-e, and the UE 115-f. The group identifier and group member radio network temporary identifier may be assigned and known by both the network entity 105-b and the group of UEs 115.

At 315, the UE 115-d may perform a beam management procedure to measure multiple transmit beams and identify a transmit beam for communications between the network entity 105-b and the UE 115-d, the UE 115-e, and the UE 115-f. For power saving purposes, and according to one or more aspects of the present disclosure, the beam management procedure may be performed by the UE 115-d only. In some cases, the network entity 105-b may instruct the UE 115-d to perform beam tracking in a group radio network temporary identifier scrambled down, once the network entity 105-b is aware the group formation. In such cases, the UE 115-e and the UE 115-f may not be configured for the beam management procedure. In some other cases, the UE 115-f may leave the group. In such cases, the network entity 105-b may transmit a CSI-RS to the UE 115-f to perform the beam management procedure.

At 320, the UE 115-d may transmit, and the network entity 105-b may receive, a message indicating the transmit beam of the set of transmit beams. For example, the UE 115-d may transmit a channel state information report and corresponding reference signal receive power measurement report indicating the identified transmission beam. In some cases, the UE 115-d may transmit to the UE 115-e, the UE 115-c, or both a second message indicating the identified transmit beam.

At 325, the network entity 105-b may transmit a transmission configuration indication associated with the identified transmit beam to the UE 115-d. The UE 115-d may forward the transmission configuration indication to the UE 115-e and the UE 115-f via a sidelink communication channel. Alternatively, at 330, the network entity 105-b may indicate the transmission configuration indication to the UE 115-d, the UE 115-e, and the UE 115-f (individually). Additionally, or alternatively, the network entity 105-b may indicate the transmission configuration indication via a downlink control information signaling. In some examples, the downlink control information signaling may be scrambled using an identifier for the UE group associated with the UE (e.g., group-ID scrambled downlink control information). In some cases, the UE 115-d may perform beam information sharing for a recommended receive beam. For example, the UE 115-d may indicate to the UE 115-e and the UE 115-f the recommended receive beam via a sidelink communication indication. In such cases, the UE 115-e and the UE 115-f may determine how to communicate using the indicated receive beam received from the UE 115-d.

In some implementations, the UE 115-e and the UE 115-f may perform a beam recovery procedure. In the case of beam failure, the UE 115-e and the UE 115-f may track wider or finer beams and report the beams to the network entity 105-b. For example, the UE 115-e and the UE 115-f may determine beam failure based on downlink block error rates, consecutive decoding failures, or reference signal receive power measurements. Upon detection of beam failure, the UE 115-e and the UE 115-f may report information associated with the tracked wider and finer beams to the network entity 105-b.

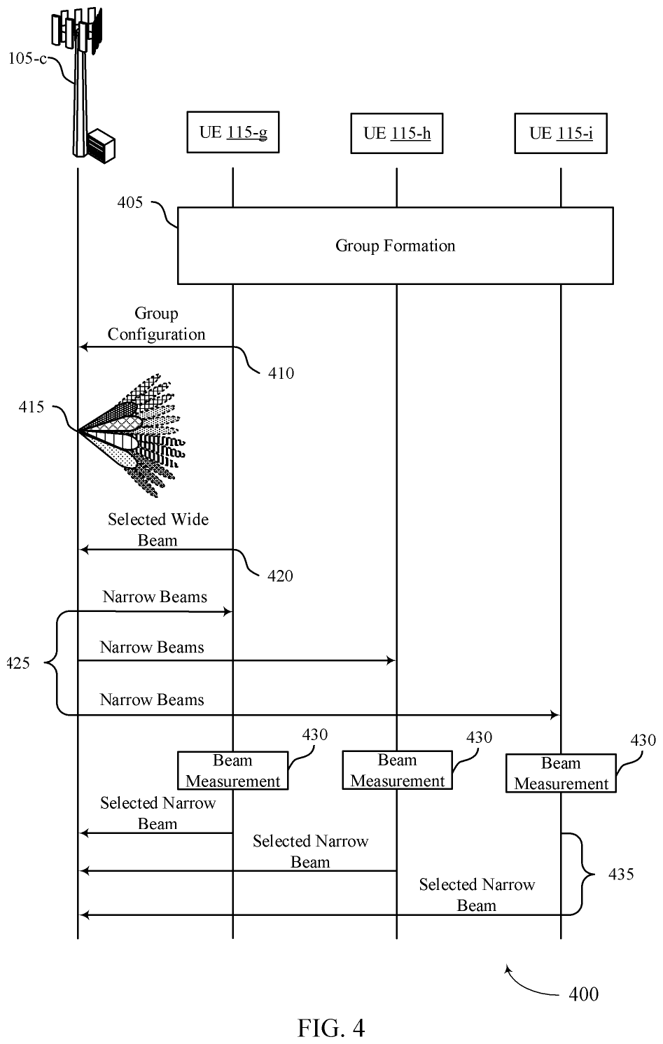

FIG. 4 illustrates an example of a process flow 400 that supports beam management procedure for a UE group in accordance with one or more aspects of the present disclosure. The process flow 400 may implement or be implemented by aspects of the wireless communications system 100, the wireless communications system 200, and the process flow 400 as described herein with reference to FIGS. 1 through 3. For example, the process flow 400 may include a network entity 105-c, which may be an example of corresponding network entities 105 described with reference to FIGS. 1 through 3. Likewise, the process flow 400 may include a UE 115-g, a UE 115-h, and a UE 115-i which may be examples of corresponding UEs 115 described with reference to FIGS. 1 through 3.

At 405, the UE 115-g, the UE 115-h, and the UE 115-i may form a group. The group of UEs may be similar to corresponding groups described herein with reference to FIGS. 1 through 3. Furthermore, the UE 115-g may be the group leader UE, while the UE 115-h and the UE 115-i may be the group member UEs. At 410, the UE 115-g may transmit an indication of the group configuration to the network entity 105-c. The indication message may include identification of the group leader UE, identification of the group member UEs, and an identifier mapping between the UE 115-g and the UE 115-h and the UE 115-i.

At 415, the UE 115-g may perform a coarse beam sweeping procedure to identify a set of narrow transmission beams. For example, each coarse beam of the set of coarse beams may include a set of narrow transmission. The UE 115-g may measure the set of coarse beams based on synchronization signal blocks, and may identify the coarse beam for communications. At 420, the UE 115-g may transmit an indication of an implicit coarse beam index to the network entity 105-c.

At 425, the network entity 105-c may transmit an indication of narrow transmit beam resources to the UE 115-h and the UE 115-i. For example, the network entity may configure the narrow transmit beam resources to the UE 115-h and the UE 115-g based on the coarse beam report from the UE 115-g. In some cases, the network entity may enable the UE 115-h and the UE 115-i to measure all of the narrow transmission beam resources. In some other cases, the network entity 105-c may assign the UE 115-h and the UE 115-i to measure a subset of the narrow beams.

At 430, the UE 115-g, the UE 115-h, and the UE 115-i may perform beam measurements on the received set of narrow transmission beams to identify a narrow transmission beam for communication with the network entity 105-c. At 435, the UE 115-g, the UE 115-h, and the UE 115-i may transmit the selected narrow beam to the network entity 105-c. The network entity 105-c may determine the narrow beam for the UE 115-g, the UE 115-h, and the UE 115-i based on beam sweeping reports from all group member UEs. In some cases, the network entity 105-c may determine the serving beam for the UE 115-g and indicate the service beam via a transmission configuration indication message. Alternatively, the network entity may determine the serving beam for all members of the group based on the reported reference signal receive power for each beam measurement.

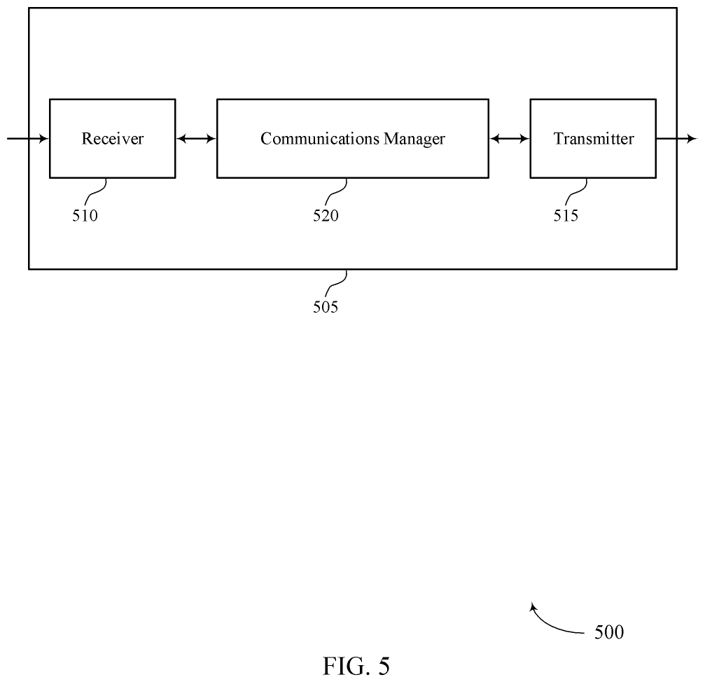

FIG. 5 shows a block diagram 500 of a device 505 that supports beam management procedure for a UE group in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to beam management procedure for a UE group). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to beam management procedure for a UE group). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of beam management procedure for a UE group as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The communications manager 520 may be configured as or otherwise support a means for performing a beam management procedure to measure a set of multiple transmit beams and identify a transmit beam of the set of multiple transmit beams for communications between the network entity and the UE group. The communications manager 520 may be configured as or otherwise support a means for transmitting a message indicating the transmit beam of the set of multiple transmit beams.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

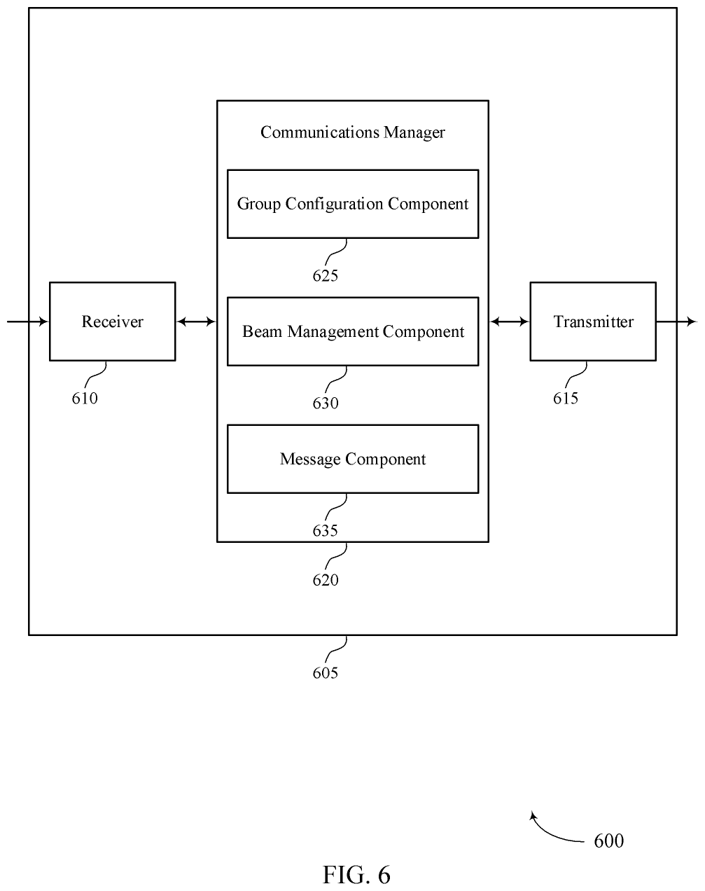

FIG. 6 shows a block diagram 600 of a device 605 that supports beam management procedure for a UE group in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to beam management procedure for a UE group). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to beam management procedure for a UE group). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of beam management procedure for a UE group as described herein. For example, the communications manager 620 may include a group configuration component 625, a beam management component 630, a message component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The group configuration component 625 may be configured as or otherwise support a means for transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The beam management component 630 may be configured as or otherwise support a means for performing a beam management procedure to measure a set of multiple transmit beams and identify a transmit beam of the set of multiple transmit beams for communications between the network entity and the UE group. The message component 635 may be configured as or otherwise support a means for transmitting a message indicating the transmit beam of the set of multiple transmit beams.

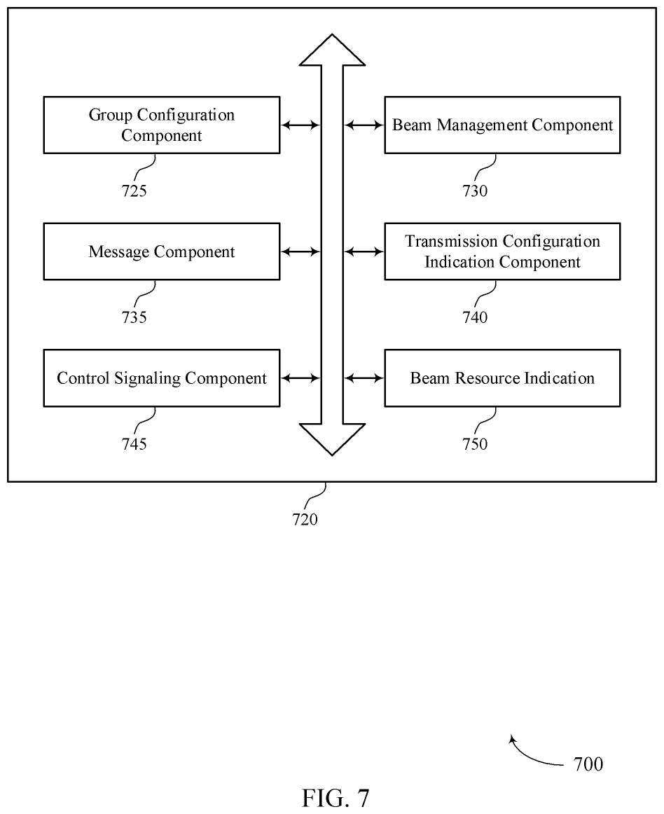

FIG. 7 shows a block diagram 700 of a communications manager 720 that supports beam management procedure for a UE group in accordance with one or more aspects of the present disclosure. The communications manager 720 may be an example of aspects of a communications manager 520, a communications manager 620, or both, as described herein. The communications manager 720, or various components thereof, may be an example of means for performing various aspects of beam management procedure for a UE group as described herein. For example, the communications manager 720 may include a group configuration component 725, a beam management component 730, a message component 735, a transmission configuration indication component 740, a control signaling component 745, a beam resource indication 750, or any combination thereof. Each of these components may communicate, directly or indirectly, with one another (e.g., via one or more buses).

The communications manager 720 may support wireless communication at a UE in accordance with examples as disclosed herein. The group configuration component 725 may be configured as or otherwise support a means for transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The beam management component 730 may be configured as or otherwise support a means for performing a beam management procedure to measure a set of multiple transmit beams and identify a transmit beam of the set of multiple transmit beams for communications between the network entity and the UE group. The message component 735 may be configured as or otherwise support a means for transmitting a message indicating the transmit beam of the set of multiple transmit beams.

In some examples, to support transmitting the message, the message component 735 may be configured as or otherwise support a means for transmitting a channel state information reference signal resource indication associated with the transmit beam of the set of multiple transmit beams or a reference signal receive power measurement report associated with the transmit beam of the set of multiple transmit beams, or both.

In some examples, the message component 735 may be configured as or otherwise support a means for transmitting, to the one or more group member UEs, a second message indicating the transmit beam of the set of multiple transmit beams. In some examples, the transmission configuration indication component 740 may be configured as or otherwise support a means for receiving, from the network entity, a transmission configuration indication associated with the transmit beam of the set of multiple transmit beams.

In some examples, the control signaling component 745 may be configured as or otherwise support a means for transmitting, to the one or more group member UEs, a sidelink control information signaling indicating the transmission configuration indication associated with the transmit beam of the set of multiple transmit beams.

In some examples, the control signaling component 745 may be configured as or otherwise support a means for receiving, from the network entity, a downlink control information signaling including a transmission configuration indication associated with the transmit beam of the set of multiple transmit beams, where the downlink control information signaling is scrambled using an identifier for the UE group associated with the UE. In some examples, the downlink control information signaling includes a request for the UE to perform the beam management procedure.

In some examples, the beam resource indication 750 may be configured as or otherwise support a means for receiving, from the network entity, an indication of transmit beam resources based on transmitting the message indicating the transmit beam, where the transmit beam resources are associated with a set of narrow transmit beams. In some examples, the set of narrow transmit beams include a subset of beams associated with the transmit beam indicated in the message.

In some examples, the beam management component 730 may be configured as or otherwise support a means for performing a second beam management procedure to measure the set of narrow transmit beams. In some examples, the message component 735 may be configured as or otherwise support a means for transmitting, to the network entity, a second message indicating a narrow transmit beam of the set of narrow transmit beams based on the second beam management procedure. In some examples, the beam management component 730 may be configured as or otherwise support a means for performing a beam failure detection for the group leader UE and the one or more group member UEs of the UE group.

In some examples, the beam management component 730 may be configured as or otherwise support a means for transmitting, to the one or more group member UEs, a request to monitor for a beam failure detection for the group leader UE and the one or more group member UEs of the UE group and to perform a beam failure recovery based on performing the beam failure detection.

In some examples, the group leader UE and the one or more group member UEs of the UE group communicate according to a new transmit beam based on the beam failure recovery. In some examples, the request includes a groupcast request including an identifier for the UE group or a broadcast request including the identifier for the UE group.

In some examples, the message component 735 may be configured as or otherwise support a means for transmitting, to the network entity, a second message including an indication of at least one motion estimate for the group leader UE and the one or more group member UEs of the UE group. In some examples, the at least one motion estimate includes a moving direction, a velocity, or both.

In some examples, the message component 735 may be configured as or otherwise support a means for transmitting, to the network entity, a second message including an indication of a recommended beam index subset or a restricted beam index subset or both for the group leader UE and the one or more group member UEs of the UE group.

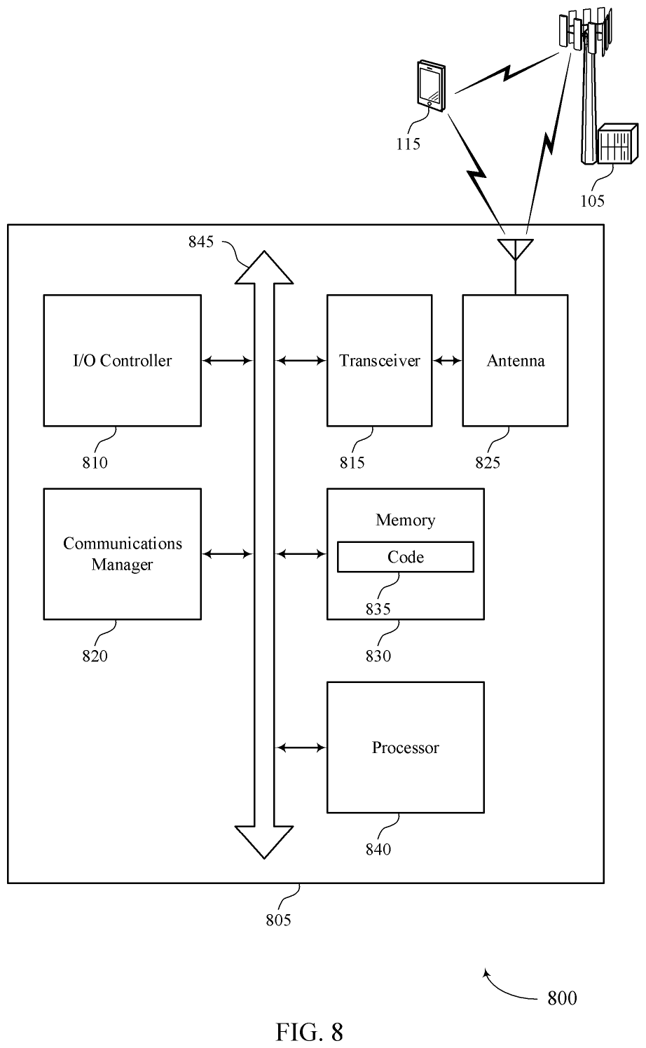

FIG. 8 shows a diagram of a system 800 including a device 805 that supports beam management procedure for a UE group in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting beam management procedure for a UE group). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The communications manager 820 may be configured as or otherwise support a means for performing a beam management procedure to measure a set of multiple transmit beams and identify a transmit beam of the set of multiple transmit beams for communications between the network entity and the UE group. The communications manager 820 may be configured as or otherwise support a means for transmitting a message indicating the transmit beam of the set of multiple transmit beams.

By including or configuring the communications manager 820 in accordance with examples as described herein, the device 805 may support techniques for improved communication reliability, reduced latency, improved user experience related to reduced processing, reduced power consumption, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of beam management procedure for a UE group as described herein, or the processor 840 and the memory 830 may be otherwise configured to perform or support such operations.

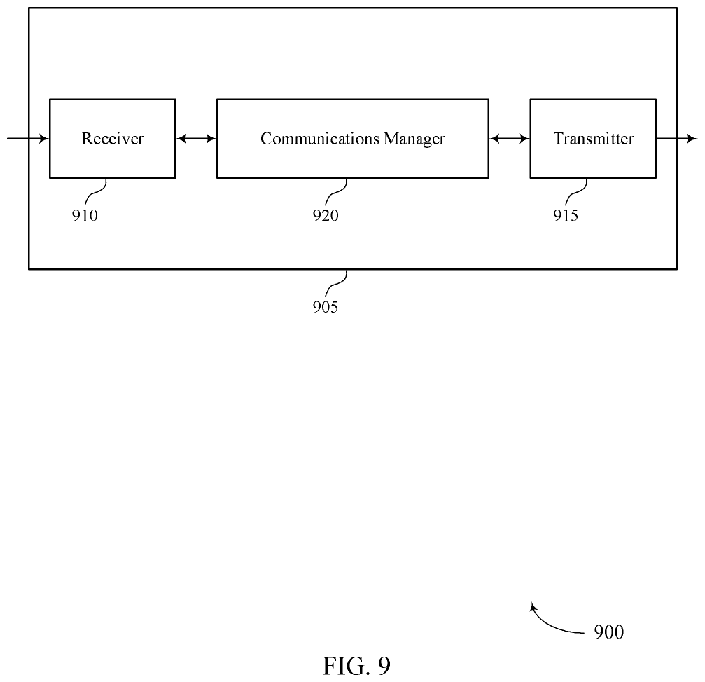

FIG. 9 shows a block diagram 900 of a device 905 that supports beam management procedure for a UE group in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of beam management procedure for a UE group as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The communications manager 920 may be configured as or otherwise support a means for receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

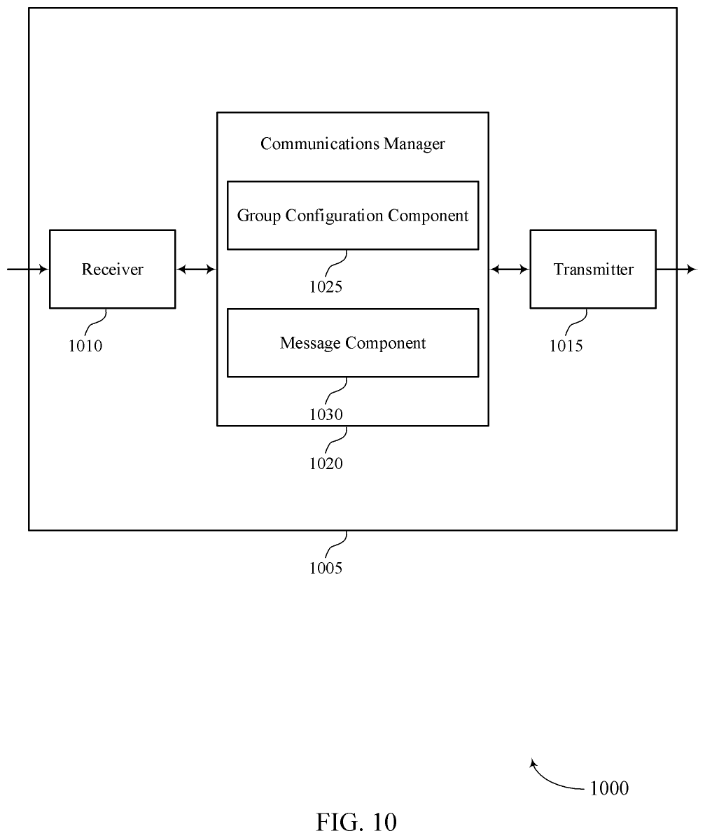

FIG. 10 shows a block diagram 1000 of a device 1005 that supports beam management procedure for a UE group in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of beam management procedure for a UE group as described herein. For example, the communications manager 1020 may include a group configuration component 1025 a message component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The group configuration component 1025 may be configured as or otherwise support a means for receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The message component 1030 may be configured as or otherwise support a means for receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

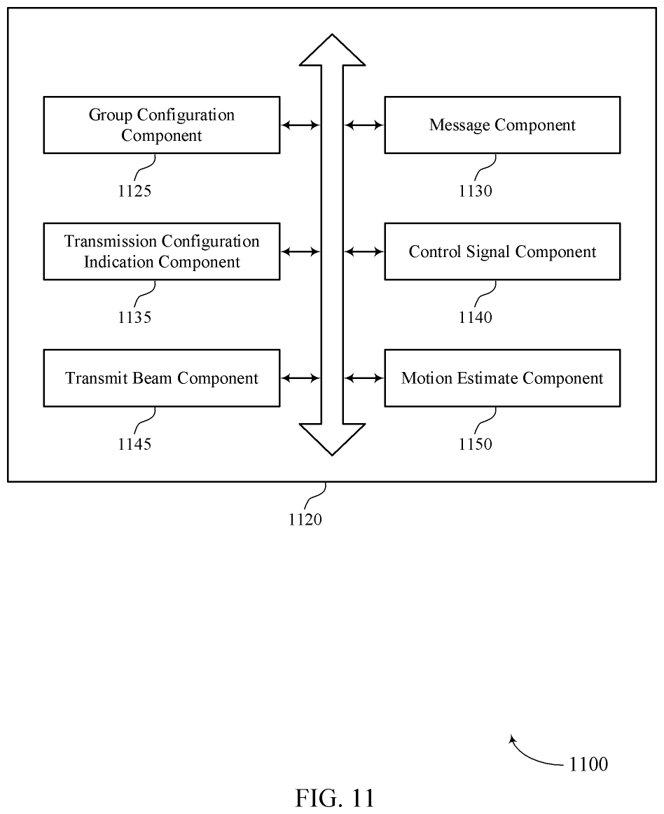

FIG. 11 shows a block diagram 1100 of a communications manager 1120 that supports beam management procedure for a UE group in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of beam management procedure for a UE group as described herein. For example, the communications manager 1120 may include a group configuration component 1125, a message component 1130, a transmission configuration indication component 1135, a control signal component 1140, a transmit beam component 1145, a motion estimate component 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The group configuration component 1125 may be configured as or otherwise support a means for receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The message component 1130 may be configured as or otherwise support a means for receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

In some examples, to support receiving the message, the message component 1130 may be configured as or otherwise support a means for receiving, from the UE, a channel state information reference signal resource indication associated with the transmit beam of the set of multiple transmit beams or a reference signal receive power measurement report associated with the transmit beam of the set of multiple transmit beams or both.

In some examples, the transmission configuration indication component 1135 may be configured as or otherwise support a means for transmitting a transmission configuration indication associated with the transmit beam of the set of multiple transmit beams. In some examples, to support transmitting, the transmission configuration indication component 1135 may be configured as or otherwise support a means for transmitting the transmission configuration indication to the group leader UE or to the group leader UE and the one or more group member UEs of the UE group.

In some examples, the control signal component 1140 may be configured as or otherwise support a means for transmitting, to the UE, a downlink control information signaling including a transmission configuration indication associated with the transmit beam of the set of multiple transmit beams, where the downlink control information signaling is scrambled using an identifier for the UE group associated with the UE. In some examples, the downlink control information signaling includes a request for the UE to perform the beam management procedure.

In some examples, the transmit beam component 1145 may be configured as or otherwise support a means for transmitting, to the UE, an indication of transmit beam resources based on receiving the message indicating the transmit beam, where the transmit beam resources are associated with a set of narrow transmit beams. In some examples, the set of narrow transmit beams include a subset of beams associated with the transmit beam indicated in the message.

In some examples, the transmit beam component 1145 may be configured as or otherwise support a means for receiving, from the group leader UE and the one or more group member UEs, a set of multiple messages indicating a set of multiple narrow transmit beams of the set of narrow transmit beams. In some examples, the transmit beam component 1145 may be configured as or otherwise support a means for transmitting an indication of a narrow transmit beam of the set of narrow transmit beams selected for each of the group leader UE and the one or more group member UEs based on receiving the set of multiple messages.

In some examples, the motion estimate component 1150 may be configured as or otherwise support a means for receiving, from the UE, a second message including an indication of at least one motion estimate for the group leader UE and the one or more group member UEs of the UE group. In some examples, the at least one motion estimate includes a moving direction, a velocity, or both.

In some examples, the message component 1130 may be configured as or otherwise support a means for receiving, from the UE, a second message including an indication of a recommended beam index subset or a restricted beam index subset or both for the group leader UE and the one or more group member UEs of the UE group.

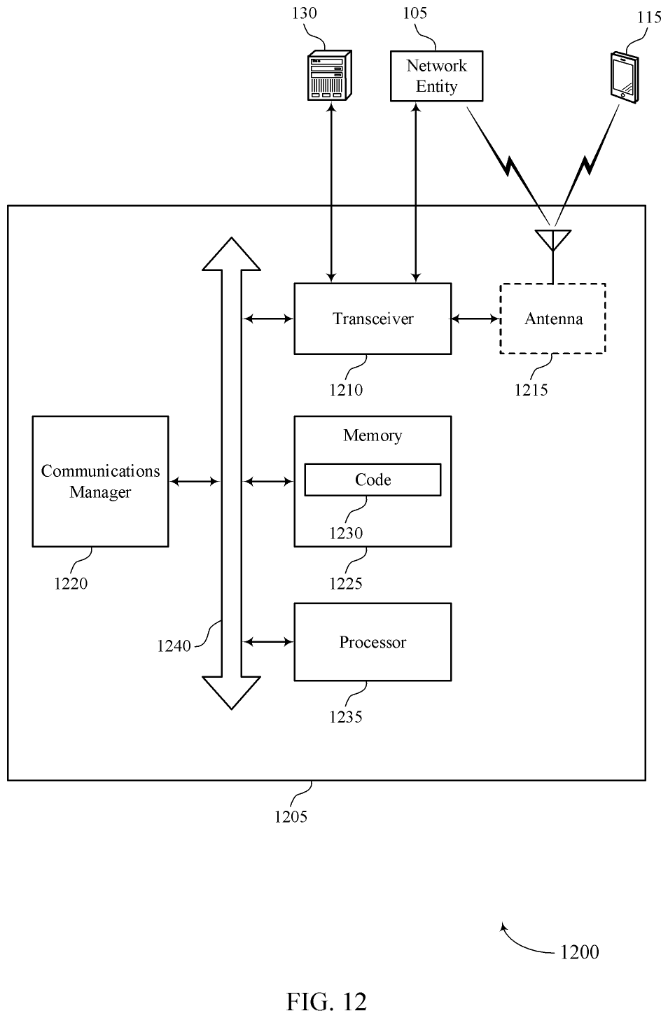

FIG. 12 shows a diagram of a system 1200 including a device 1205 that supports beam management procedure for a UE group in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting beam management procedure for a UE group). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The communications manager 1220 may be configured as or otherwise support a means for receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group.

By including or configuring the communications manager 1220 in accordance with examples as described herein, the device 1205 may support techniques for improved communication reliability, reduced latency, improved user experience related to reduced processing, reduced power consumption, and more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of beam management procedure for a UE group as described herein, or the processor 1235 and the memory 1225 may be otherwise configured to perform or support such operations.

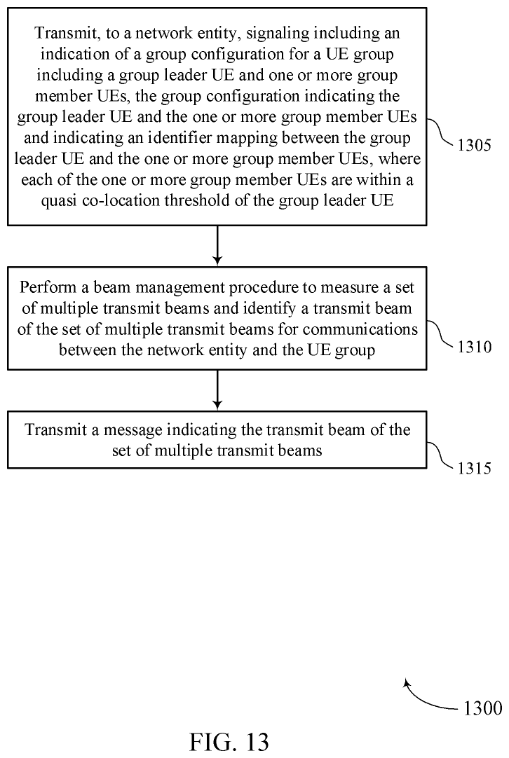

FIG. 13 shows a flowchart illustrating a method 1300 that supports beam management procedure for a UE group in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The operations of 1305 may be performed in accordance with examples as disclosed herein. In some examples, aspects of the operations of 1305 may be performed by a group configuration component 725 as described with reference to FIG. 7.

At 1310, the method may include performing a beam management procedure to measure a set of multiple transmit beams and identify a transmit beam of the set of multiple transmit beams for communications between the network entity and the UE group. The operations of 1310 may be performed in accordance with examples as disclosed herein. In some examples, aspects of the operations of 1310 may be performed by a beam management component 730 as described with reference to FIG. 7.

At 1315, the method may include transmitting a message indicating the transmit beam of the set of multiple transmit beams. The operations of 1315 may be performed in accordance with examples as disclosed herein. In some examples, aspects of the operations of 1315 may be performed by a message component 735 as described with reference to FIG. 7.

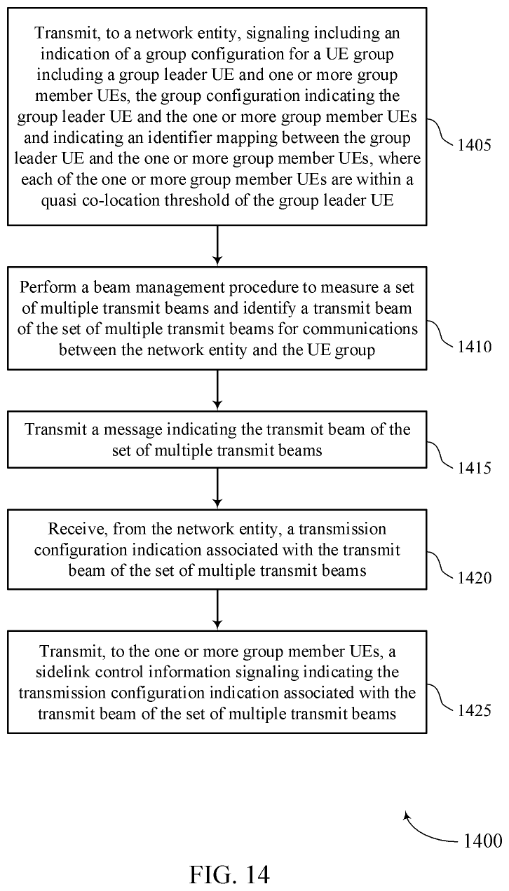

FIG. 14 shows a flowchart illustrating a method 1400 that supports beam management procedure for a UE group in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, to a network entity, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The operations of 1405 may be performed in accordance with examples as disclosed herein. In some examples, aspects of the operations of 1405 may be performed by a group configuration component 725 as described with reference to FIG. 7.

At 1410, the method may include performing a beam management procedure to measure a set of multiple transmit beams and identify a transmit beam of the set of multiple transmit beams for communications between the network entity and the UE group. The operations of 1410 may be performed in accordance with examples as disclosed herein. In some examples, aspects of the operations of 1410 may be performed by a beam management component 730 as described with reference to FIG. 7.

At 1415, the method may include transmitting a message indicating the transmit beam of the set of multiple transmit beams. The operations of 1415 may be performed in accordance with examples as disclosed herein. In some examples, aspects of the operations of 1415 may be performed by a message component 735 as described with reference to FIG. 7.

At 1420, the method may include receiving, from the network entity, a transmission configuration indication associated with the transmit beam of the set of multiple transmit beams. The operations of 1420 may be performed in accordance with examples as disclosed herein. In some examples, aspects of the operations of 1420 may be performed by a transmission configuration indication component 740 as described with reference to FIG. 7.

At 1425, the method may include transmitting, to the one or more group member UEs, a sidelink control information signaling indicating the transmission configuration indication associated with the transmit beam of the set of multiple transmit beams. The operations of 1425 may be performed in accordance with examples as disclosed herein. In some examples, aspects of the operations of 1425 may be performed by a control signaling component 745 as described with reference to FIG. 7.

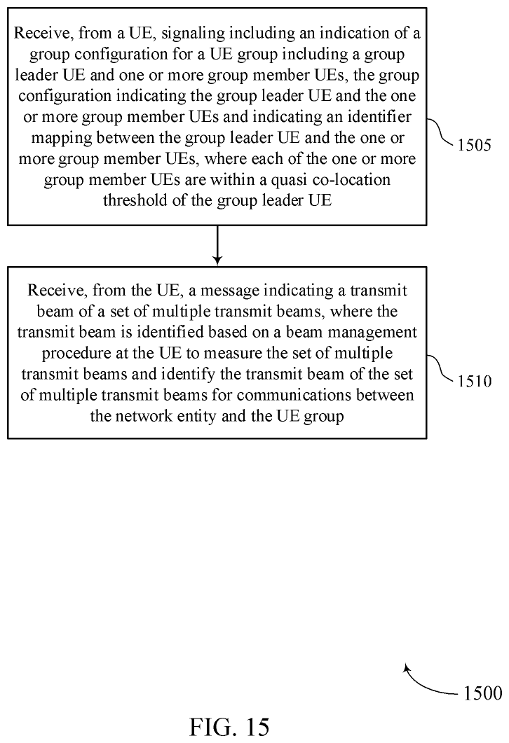

FIG. 15 shows a flowchart illustrating a method 1500 that supports beam management procedure for a UE group in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The operations of 1505 may be performed in accordance with examples as disclosed herein. In some examples, aspects of the operations of 1505 may be performed by a group configuration component 1125 as described with reference to FIG. 11.

At 1510, the method may include receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group. The operations of 1510 may be performed in accordance with examples as disclosed herein. In some examples, aspects of the operations of 1510 may be performed by a message component 1130 as described with reference to FIG. 11.

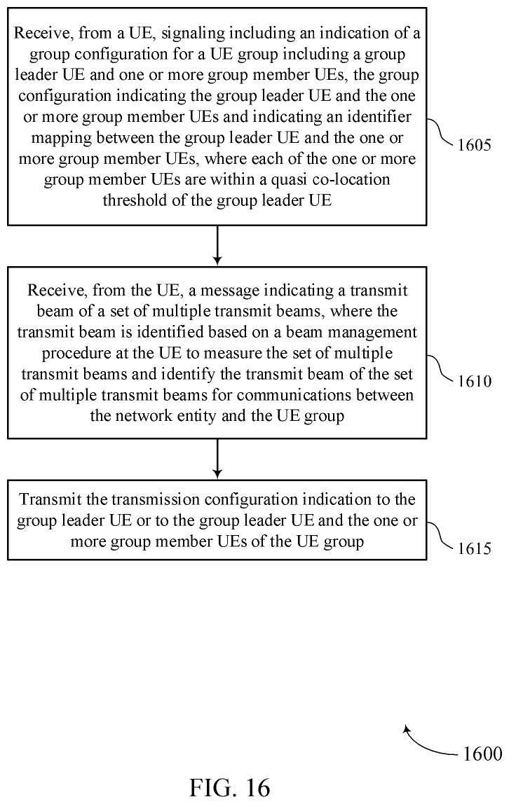

FIG. 16 shows a flowchart illustrating a method 1600 that supports beam management procedure for a UE group in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving, from a UE, signaling including an indication of a group configuration for a UE group including a group leader UE and one or more group member UEs, the group configuration indicating the group leader UE and the one or more group member UEs and indicating an identifier mapping between the group leader UE and the one or more group member UEs, where each of the one or more group member UEs are within a quasi co-location threshold of the group leader UE. The operations of 1605 may be performed in accordance with examples as disclosed herein. In some examples, aspects of the operations of 1605 may be performed by a group configuration component 1125 as described with reference to FIG. 11.

At 1610, the method may include receiving, from the UE, a message indicating a transmit beam of a set of multiple transmit beams, where the transmit beam is identified based on a beam management procedure at the UE to measure the set of multiple transmit beams and identify the transmit beam of the set of multiple transmit beams for communications between the network entity and the UE group. The operations of 1610 may be performed in accordance with examples as disclosed herein. In some examples, aspects of the operations of 1610 may be performed by a message component 1130 as described with reference to FIG. 11.

At 1615, the method may include transmitting the transmission configuration indication to the group leader UE or to the group leader UE and the one or more group member UEs of the UE group. The operations of 1615 may be performed in accordance with examples as disclosed herein. In some examples, aspects of the operations of 1615 may be performed by a transmission configuration indication component 1135 as described with reference to FIG. 11.

The following provides an overview of aspects of the present disclosure:

Aspect 1: A method for wireless communication at a UE, comprising: transmitting, to a network entity, signaling comprising an indication of a group configuration for a UE group comprising a group leader UE and one or more group member UEs, the group configuration indicating the group leader UE and the one or more group member UEs and indicating an identifier mapping between the group leader UE and the one or more group member UEs, wherein each of the one or more group member UEs are within a quasi co-location threshold of the group leader UE; performing a beam management procedure to measure a plurality of transmit beams and identify a transmit beam of the plurality of transmit beams for communications between the network entity and the UE group; and transmitting a message indicating the transmit beam of the plurality of transmit beams.

Aspect 2: The method of aspect 1, wherein transmitting the message further comprises: transmitting a channel state information reference signal resource indication associated with the transmit beam of the plurality of transmit beams or a reference signal receive power measurement report associated with the transmit beam of the plurality of transmit beams, or both.

Aspect 3: The method of any of aspects 1 through 2, further comprising: transmitting, to the one or more group member UEs, a second message indicating the transmit beam of the plurality of transmit beams.

Aspect 4: The method of any of aspects 1 through 3, further comprising: receiving, from the network entity, a transmission configuration indication associated with the transmit beam of the plurality of transmit beams.

Aspect 5: The method of aspect 4, further comprising: transmitting, to the one or more group member UEs, a sidelink control information signaling indicating the transmission configuration indication associated with the transmit beam of the plurality of transmit beams.

Aspect 6: The method of any of aspects 1 through 5, further comprising: receiving, from the network entity, a downlink control information signaling comprising a transmission configuration indication associated with the transmit beam of the plurality of transmit beams, wherein the downlink control information signaling is scrambled using an identifier for the UE group associated with the UE.

Aspect 7: The method of aspect 6, wherein the downlink control information signaling comprises a request for the UE to perform the beam management procedure.

Aspect 8: The method of any of aspects 1 through 7, further comprising: receiving, from the network entity, an indication of transmit beam resources based at least in part on transmitting the message indicating the transmit beam, wherein the transmit beam resources are associated with a set of narrow transmit beams.

Aspect 9: The method of aspect 8, wherein the set of narrow transmit beams comprise a subset of beams associated with the transmit beam indicated in the message.

Aspect 10: The method of any of aspects 8 through 9, further comprising: performing a second beam management procedure to measure the set of narrow transmit beams; and transmitting, to the network entity, a second message indicating a narrow transmit beam of the set of narrow transmit beams based at least in part on the second beam management procedure.

Aspect 11: The method of any of aspects 1 through 10, further comprising: performing a beam failure detection for the group leader UE and the one or more group member UEs of the UE group.

Aspect 12: The method of any of aspects 1 through 11, further comprising: transmitting, to the one or more group member UEs, a request to monitor for a beam failure detection for the group leader UE and the one or more group member UEs of the UE group and to perform a beam failure recovery based at least in part on performing the beam failure detection.

Aspect 13: The method of aspect 12, wherein the group leader UE and the one or more group member UEs of the UE group communicate according to a new transmit beam based at least in part on the beam failure recovery.

Aspect 14: The method of any of aspects 12 through 13, wherein the request comprises a groupcast request including an identifier for the UE group or a broadcast request including the identifier for the UE group.

Aspect 15: The method of any of aspects 1 through 14, further comprising: transmitting, to the network entity, a second message comprising an indication of at least one motion estimate for the group leader UE and the one or more group member UEs of the UE group.

Aspect 16: The method of aspect 15, wherein the at least one motion estimate comprises a moving direction, a velocity, or both.

Aspect 17: The method of any of aspects 1 through 16, further comprising: transmitting, to the network entity, a second message comprising an indication of a recommended beam index subset or a restricted beam index subset or both for the group leader UE and the one or more group member UEs of the UE group.

Aspect 18: A method for wireless communication at a network entity, comprising: receiving, from a UE, signaling comprising an indication of a group configuration for a UE group comprising a group leader UE and one or more group member UEs, the group configuration indicating the group leader UE and the one or more group member UEs and indicating an identifier mapping between the group leader UE and the one or more group member UEs, wherein each of the one or more group member UEs are within a quasi co-location threshold of the group leader UE; and receiving, from the UE, a message indicating a transmit beam of a plurality of transmit beams, wherein the transmit beam is identified based at least in part on a beam management procedure at the UE to measure the plurality of transmit beams and identify the transmit beam of the plurality of transmit beams for communications between the network entity and the UE group.

Aspect 19: The method of aspect 18, wherein receiving the message further comprises: receiving, from the UE, a channel state information reference signal resource indication associated with the transmit beam of the plurality of transmit beams or a reference signal receive power measurement report associated with the transmit beam of the plurality of transmit beams or both.

Aspect 20: The method of any of aspects 18 through 19, further comprising: transmitting a transmission configuration indication associated with the transmit beam of the plurality of transmit beams.

Aspect 21: The method of aspect 20, wherein the transmitting further comprises: transmitting the transmission configuration indication to the group leader UE or to the group leader UE and the one or more group member UEs of the UE group.

Aspect 22: The method of any of aspects 18 through 21, further comprising: transmitting, to the UE, a downlink control information signaling comprising a transmission configuration indication associated with the transmit beam of the plurality of transmit beams, wherein the downlink control information signaling is scrambled using an identifier for the UE group associated with the UE.

Aspect 23: The method of aspect 22, wherein the downlink control information signaling comprises a request for the UE to perform the beam management procedure.

Aspect 24: The method of any of aspects 18 through 23, further comprising: transmitting, to the UE, an indication of transmit beam resources based at least in part on receiving the message indicating the transmit beam, wherein the transmit beam resources are associated with a set of narrow transmit beams.

Aspect 25: The method of aspect 24, wherein the set of narrow transmit beams comprise a subset of beams associated with the transmit beam indicated in the message.

Aspect 26: The method of any of aspects 24 through 25, further comprising: receiving, from the group leader UE and the one or more group member UEs, a plurality of messages indicating a plurality of narrow transmit beams of the set of narrow transmit beams; and transmitting an indication of a narrow transmit beam of the set of narrow transmit beams selected for each of the group leader UE and the one or more group member UEs based at least in part receiving the plurality of messages.

Aspect 27: The method of any of aspects 18 through 26, further comprising: receiving, from the UE, a second message comprising an indication of at least one motion estimate for the group leader UE and the one or more group member UEs of the UE group.

Aspect 28: The method of aspect 27, wherein the at least one motion estimate comprises a moving direction, a velocity, or both.

Aspect 29: The method of any of aspects 18 through 28, further comprising: receiving, from the UE, a second message comprising an indication of a recommended beam index subset or a restricted beam index subset or both for the group leader UE and the one or more group member UEs of the UE group.

Aspect 30: An apparatus for wireless communication at a UE, comprising a processor; memory coupled with the processor; and instructions stored in the memory and executable by the processor to cause the apparatus to perform a method of any of aspects 1 through 17.

Aspect 31: An apparatus for wireless communication at a UE, comprising at least one means for performing a method of any of aspects 1 through 17.

Aspect 32: A non-transitory computer-readable medium storing code for wireless communication at a UE, the code comprising instructions executable by a processor to perform a method of any of aspects 1 through 17.

Aspect 33: An apparatus for wireless communication at a network entity, comprising a processor; memory coupled with the processor; and instructions stored in the memory and executable by the processor to cause the apparatus to perform a method of any of aspects 18 through 29.

Aspect 34: An apparatus for wireless communication at a network entity, comprising at least one means for performing a method of any of aspects 18 through 29.

Aspect 35: A non-transitory computer-readable medium storing code for wireless communication at a network entity, the code comprising instructions executable by a processor to perform a method of any of aspects 18 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting, to a network entity, signaling comprising an indication of a group configuration for a UE group comprising a group leader UE and one or more group member UEs, the group configuration indicating the group leader UE and the one or more group member UEs and indicating an identifier mapping between the group leader UE and the one or more group member UEs, wherein each of the one or more group member UEs are within a quasi co-location threshold of the group leader UE;
performing a beam management procedure to measure a plurality of transmit beams and identify a transmit beam of the plurality of transmit beams for communications between the network entity and the UE group; and
transmitting a message indicating the transmit beam of the plurality of transmit beams.

2. The method of claim 1, wherein transmitting the message further comprises:
transmitting a channel state information reference signal resource indication associated with the transmit beam of the plurality of transmit beams or a reference signal receive power measurement report associated with the transmit beam of the plurality of transmit beams, or both.

3. The method of claim 1, further comprising:
transmitting, to the one or more group member UEs, a second message indicating the transmit beam of the plurality of transmit beams.

4. The method of claim 1, further comprising:
receiving, from the network entity, a transmission configuration indication associated with the transmit beam of the plurality of transmit beams.

5. The method of claim 4, further comprising:
transmitting, to the one or more group member UEs, a sidelink control information signaling indicating the transmission configuration indication associated with the transmit beam of the plurality of transmit beams.

6. The method of claim 1, further comprising:
receiving, from the network entity, a downlink control information signaling comprising a transmission configuration indication associated with the transmit beam of the plurality of transmit beams, wherein the downlink control information signaling is scrambled using an identifier for the UE group associated with the UE.

7. The method of claim 6, wherein the downlink control information signaling comprises a request for the UE to perform the beam management procedure.

8. The method of claim 1, further comprising:
receiving, from the network entity, an indication of transmit beam resources based at least in part on transmitting the message indicating the transmit beam, wherein the transmit beam resources are associated with a set of narrow transmit beams.

9. The method of claim 8, wherein the set of narrow transmit beams comprise a subset of beams associated with the transmit beam indicated in the message.

10. The method of claim 8, further comprising:
performing a second beam management procedure to measure the set of narrow transmit beams; and
transmitting, to the network entity, a second message indicating a narrow transmit beam of the set of narrow transmit beams based at least in part on the second beam management procedure.

11. The method of claim 1, further comprising:
performing a beam failure detection for the group leader UE and the one or more group member UEs of the UE group.

12. The method of claim 1, further comprising:
transmitting, to the one or more group member UEs, a request to monitor for a beam failure detection for the group leader UE and the one or more group member UEs of the UE group and to perform a beam failure recovery based at least in part on performing the beam failure detection.

13. The method of claim 12, wherein the group leader UE and the one or more group member UEs of the UE group communicate according to a new transmit beam based at least in part on the beam failure recovery.

14. The method of claim 12, wherein the request comprises a groupcast request including an identifier for the UE group or a broadcast request including the identifier for the UE group.

15. The method of claim 1, further comprising:
transmitting, to the network entity, a second message comprising an indication of at least one motion estimate for the group leader UE and the one or more group member UEs of the UE group.

16. The method of claim 15, wherein the at least one motion estimate comprises a moving direction, a velocity, or both.

17. The method of claim 1, further comprising:
transmitting, to the network entity, a second message comprising an indication of a recommended beam index subset or a restricted beam index subset or both for the group leader UE and the one or more group member UEs of the UE group.

18. A method for wireless communication at a network entity, comprising:
receiving, from a user equipment (UE), signaling comprising an indication of a group configuration for a UE group comprising a group leader UE and one or more group member UEs, the group configuration indicating the group leader UE and the one or more group member UEs and indicating an identifier mapping between the group leader UE and the one or more group member UEs, wherein each of the one or more group member UEs are within a quasi co-location threshold of the group leader UE; and
receiving, from the UE, a message indicating a transmit beam of a plurality of transmit beams, wherein the transmit beam is identified based at least in part on a beam management procedure at the UE to measure the plurality of transmit beams and identify the transmit beam of the plurality of transmit beams for communications between the network entity and the UE group.

19. The method of claim 18, wherein receiving the message further comprises:
receiving, from the UE, a channel state information reference signal resource indication associated with the transmit beam of the plurality of transmit beams or a reference signal receive power measurement report associated with the transmit beam of the plurality of transmit beams or both.

20. The method of claim 18, further comprising:
transmitting a transmission configuration indication associated with the transmit beam of the plurality of transmit beams.

21. The method of claim 20, wherein the transmitting further comprises:
transmitting the transmission configuration indication to the group leader UE or to the group leader UE and the one or more group member UEs of the UE group.

22. The method of claim 18, further comprising:
transmitting, to the UE, a downlink control information signaling comprising a transmission configuration indication associated with the transmit beam of the plurality of transmit beams, wherein the downlink control information signaling is scrambled using an identifier for the UE group associated with the UE.

23. The method of claim 22, wherein the downlink control information signaling comprises a request for the UE to perform the beam management procedure.

24. The method of claim 18, further comprising:
transmitting, to the UE, an indication of transmit beam resources based at least in part on receiving the message indicating the transmit beam, wherein the transmit beam resources are associated with a set of narrow transmit beams.

25. The method of claim 24, wherein the set of narrow transmit beams comprise a subset of beams associated with the transmit beam indicated in the message.

26. The method of claim 24, further comprising:
receiving, from the group leader UE and the one or more group member UEs, a plurality of messages indicating a plurality of narrow transmit beams of the set of narrow transmit beams; and
transmitting an indication of a narrow transmit beam of the set of narrow transmit beams selected for each of the group leader UE and the one or more group member UEs based at least in part on receiving the plurality of messages.

27. The method of claim 18, further comprising:
receiving, from the UE, a second message comprising an indication of at least one motion estimate for the group leader UE and the one or more group member UEs of the UE group.

28. The method of claim 18, further comprising:
receiving, from the UE, a second message comprising an indication of a recommended beam index subset or a restricted beam index subset or both for the group leader UE and the one or more group member UEs of the UE group.

29. An apparatus for wireless communication at a user equipment (UE), comprising:
a processor;
memory coupled with the processor; and
instructions stored in the memory and executable by the processor to cause the apparatus to:
transmit, to a network entity, signaling comprising an indication of a group configuration for a UE group comprising a group leader UE and one or more group member UEs, the group configuration indicating the group leader UE and the one or more group member UEs and indicating an identifier mapping between the group leader UE and the one or more group member UEs, wherein each of the one or more group member UEs are within a quasi co-location threshold of the group leader UE;
perform a beam management procedure to measure a plurality of transmit beams and identify a transmit beam of the plurality of transmit beams for communications between the network entity and the UE group; and
transmit a message indicating the transmit beam of the plurality of transmit beams.

30. An apparatus for wireless communication at a network entity, comprising:
a processor;
memory coupled with the processor; and
instructions stored in the memory and executable by the processor to cause the apparatus to:
receive, from a user equipment (UE), signaling comprising an indication of a group configuration for a UE group comprising a group leader UE and one or more group member UEs, the group configuration indicating the group leader UE and the one or more group member UEs and indicating an identifier mapping between the group leader UE and the one or more group member UEs, wherein each of the one or more group member UEs are within a quasi co-location threshold of the group leader UE; and
receive, from the UE, a message indicating a transmit beam of a plurality of transmit beams, wherein the transmit beam is identified based at least in part on a beam management procedure at the UE to measure the plurality of transmit beams and identify the transmit beam of the plurality of transmit beams for communications between the network entity and the UE group.
